(19) United States
(12) Patent Application Publication
(10) Pub. No.: US 2009/0024385 A1
(43) Pub. Date: Jan. 22, 2009

(54) SEMANTIC PARSER

(75) Inventor: Martin Christian Hirsch, Berlin (DE)

Correspondence Address: INTELLECTUAL PROPERTY / TECHNOLOGY LAW, PO BOX 14329, RESEARCH TRIANGLE PARK, NC, 27709, US

(73) Assignee: SEMGINE, GMBH, Berlin (DE)

(21) Appl. No.: 11/778,529

(22) Filed: Jul. 16, 2007

(51) Int. Cl. G06F 17/20

(52) U.S. Cl. 704/9; 704/E13.011

(57) ABSTRACT

A method and an apparatus for semantic parsing of electronic text documents. The electronic text documents can comprise a plurality of sentences with several language components. The method comprises analyzing at least one sentence of the electronic text document and dynamically generating a graph from the analyzed sentence of the text document. The graph represents a semantic representation of the analyzed one or more sentences. The method continues the analysis until an ambiguous sentence is determined and analyzed by evaluating at least a portion of the generated graph.

### CROSS-REFERENCE TO RELATED APPLICATIONS

The present application is related to the following co-pending patent applications, which are assigned to the assignee of the present application and incorporated herein by reference in their entireties:

U.S. patent application Ser. No. ______/______ (Attorney Docket No. 4280-121), filed concurrently herewith in the name of Martin Christian Hirsch, and entitled “SEMANTIC CRAWLER”

### BACKGROUND OF THE INVENTION

The present invention relates to a computer aided method and an apparatus for semantic parsing, i.e. analyzing the meaning of at least a portion of one or more information sources, for example, electronic text documents of human languages. The information sources comprise one or more information portions. The information portions may be, for example, single sentences or text paragraphs with one or more information elements, for example, nouns, pronouns, verbs.

### BRIEF DESCRIPTION OF THE RELATED ART

In recent years, the processing, in particular the analyzing of a vast amount of available information sources, such as electronic text documents, Internet web pages, digital scientific publications, mailing lists, electronic text databases, etc. has become more and more important, for example, in business, science applications, etc.

As a result of the tremendous increased number of information or information sources that are, for example, available via electronic communication networks such as the Internet, intranet, etc. there is a need for efficient handling and evaluating of the vast amount of information and, in particular, to understand the meaning of the information. The processing is, in particular, assisted by computer hardware, because otherwise it is difficult, almost even impossible, for a user wanting specific information about an issue to evaluate relevant ones of the information sources in an effective way and further process all available relevant information sources for this issue.

In the field of computational linguistics attempts have been made to analyze and process languages by computer algorithms. Experience has shown that natural languages are much more complex than, for example, the structure of syntax of a programming language. The motivation behind computational linguistics is the development of automatic language processing methods and systems to be able to perform, for example, automatic translation, automatic resume of text, extraction of information from a text document, language interaction with machines, automatic check for grammatical correctness, etc.

One of the main challenges in computational linguistics is the determination of the meaning of a term in a text document, because the same term can have different meanings in dependence of its context in the text document. Further, it would be desirable if syntactic ambiguities could be clearly and definitely resolved using computer-implemented algorithms because, for example, an information portion (such as a sentence) of the text document can be analyzed and evaluated by different ways and strategies. Therefore, the main field of application of computational linguistics is the design and implementation of language-specific algorithms and strategies.

Conventional data processing methods in the field of pre-analyzing one or a plurality of information sources (like electronic text documents) that include, for example, computer programming language syntax text, context-sensitive human language text, etc. are termed “parsing methods”. Such parsing methods are known from the prior art and analyze step by step an information source in a sequential manner to determine the grammatical texture according to a set of given predefined grammar rules. The information source can contain context-free and context-sensitive information.

The so-called “parsers” or “parsing programs” can be classified into two categories of operation strategy: top-down parsing such as recursive descent parser, LL parser, Packrat parser, Unger parser, Tail recursive parser, Earley parser, etc. and bottom-up parsing such as precedence parsing, boundary context parsing, LR parser, CYK parser, etc. A parser operates in two stages: identifying meaningful tokens in the information source and transforming the tokens into a data structure. The data structure is often represented as a syntax tree that captures the implied hierarchy of the parsed and transformed information source, i.e. the text within the information source.

As already mentioned, human languages containing ambiguities can also be parsed by computer algorithms. The syntax which is used to identify the tokens depends on linguistics and computational concerns. Known parsing systems from the prior art either use, for example, lexical functional grammar theory or head-driven phrase structure grammar theory. Alternatively, dependency grammar parsing is used to avoid linguistic controversy. However, parsers provide no information to the meaning of the tokens in respect of content.

An approach for determining semantic similarity of textual items is disclosed in European Patent Application No. EP 1 515 241 A2 (Maddox, Paul Christopher). The semantic similarity is determined comparison is reached using a rules base that includes syntactic rules, grammar rules, property rules as well as ambiguity rules. The different textual items are received and their words are tagged with syntactic categories. Before a comparison between the different textual items is performed, the relevant sets of rules are applied to output a semantic feature structure. To resolve syntactic and semantic ambiguities, in particular relating uses of pronouns, the ambiguity rules are defined and applied.

### SUMMARY OF THE INVENTION

According to the present invention, there is provided a method for semantic parsing at least one information source. The at least one information source has a plurality of information portions. Each one of the plurality of information portions comprises at least one information element. The at least one information element is associated with at least one second information element. The method according to the invention is computer aided and comprises: Analyzing one of the plurality of information portions of the at least one information source and subsequently generating a graph from the plurality of information portions to obtain at least one first initial node and at least one second initial and at least one first edge. The at least one first initial node represents the at least one first information element. The at least one first initial node comprises at least one first initial weight, i.e. a first initial node weight. The at least one second initial node represents the at least one second information element. The at least one second initial node comprises at least one second initial weight, i.e. a second initial node weight. The at least one first edge connects the at least one first initial node with the at least one second initial node. Subsequently a further one of the plurality of information portions of the at least one information source is analysed to determine further ones of the at least one information elements. Further nodes are added to the generated graph. The further nodes comprise further weights. These added further nodes represent the further ones of the at least one information elements. Similarly further edges are added to the generated graph between associated ones of the added further nodes as well as associated ones of the initial nodes and the associated ones of the added further nodes. The analysis of the further ones of the plurality of information portions is continued and further nodes and further edges are added to the generated graph until a first ambiguous one of the further ones of the plurality of information portions of the at least one information source is determined and analyzed by evaluating at least a portion of the generated graph. The further nodes comprise further weights, i.e. node weights. The further edges can comprise further edge weights. So, the graph can be used for an interpretation of the analyzed one of the plurality of information portions with regard to its semantics, i.e. the meaning of the analyzed one of the plurality of information portions. In other words, the semantic interpretation of an ambiguous information portion can be performed with the structural layout of the generated graph and the structural layout of the graph as well the status, i.e. the activation and/or deactivation of nodes and/or edges, of the generated graph. The activation or deactivation of a node can be contained in the weight of each node. For example, the first initial weight can be selected from the group consisting of a frequency number and activation information of the at least one first information element. The frequency number will be further explained in detail below.

In one aspect of the invention, the information source can be, for example, an electronic text document, i.e. a text document that can be processed by an electronic data processing apparatus. The electronic text document may be of any kind, such as law text, scientific publications, novella, stories, newspaper articles, textbooks, catalogues, description texts, etc. The information source may comprise human language text. It should be noted that the kind of the information source, i.e. text document is not only limited to human language text, but can also contain computer programming language text, for example, HTTP, C, JAVA, Perl source code, etc, i.e. any other language or kind of language with a syntax, syntax elements, operators, etc. The one or more information sources can be stored, for example, on a local computer and/or distributed and accessible over a communications network such as intranets, the Internet, etc. In an alternative aspect of the invention, the at least one information source can be, for example, an electronic picture. The electronic picture can be, for example, of JPG format, TIF format, BMP format or any other format that is able to be processed, for example, by an electronic data processing apparatus such as computer, etc. According to a further aspect of the invention, the at least one information source can be, for example, an electronic music data file or video data file or any other kind of multimedia data files. The electronic music data file can be, for example, of MP3 format, WAV format, WMA format, etc.

For example, if the information source is a human language text document, the information portion is a sentence or a plurality of sentences, i.e. a paragraph. Following, an information element can be a noun, i.e. a substantive, a verb, an object, etc.

It is already well known that a sentence needs at least a basic set of such information elements of different kinds which are based on a known set of (grammar) rules. The grammar rules include information that comprises or communicates a meaning of the sentence. Nearly almost every text document of human language supplied, when constructed correctly, information, i.e. a message about something. The combination of sentences results in a message or meaning which can normally be understood by persons (readers) who are able to recognize and read the language, i.e. the readers recognize the information elements in the form of words or signs and associate a specific meaning with these information elements as components of the sentence.

With the method according to the present invention, it is, for example, possible to determine and evaluate the meaning of a text document or portions of a text document as would do a reader. The invention allows this determination and evaluation to be carried out with increased efficiency and operation speed. For example, in contrast to the previously mentioned (conventional) parsing algorithms that analyze merely the syntax of a single sentence, the method according to the present invention is able to determine and evaluate the meaning of several sentences placed together. Conventional prior art parsing algorithms merely detect the type of information elements. For example, the conventional prior art parsing algorithms detect that the information element “he” in a sentence is of category subject and is a personal pronoun. However, the conventional prior art parsing does not determine who or what is meant with the term “he” in a context-sensitive manner, i.e. with regard to and under consideration of previous analyzed sentences, wherein the sentences are represented by the structural layout and the status of a graph.

However, with the method provided by the present invention, it is possible, for example, to determine the meaning of the terms, i.e. it is possible to determine who or what is meant with the term “he” in a sentence at an arbitrary place of a text document using the generated graph. This is because the structural property, i.e. the structural layout (the system of relationships between nodes, i.e. information elements) and the status, i.e. condition of nodes and/or edges (e.g. activated or deactivated) of the graph represents a kind of previous knowledge or previous knowledge can be extracted from the graph. So the property of the generated graph according to the invention is similar to a specific level of experience with regard to analyzed sentences.

Since the method according to the present invention can be a computer implemented method, the graph can be mapped to or represented by a matrix or a vector and processed by well-known calculation operations. The method according to the present invention can, for example, extract one or more subject nouns, one or more verbs and one or more object nouns of a sentence or several sentences of an electronic text document. The extraction of these information elements can be realized, for example, by a so-called “shallow parser”. The shallow parser is used to determine the grammatical components of one or more sentences and to build up a representation, i.e. in the form of a syntax tree, of the one or more sentences. Further, these information elements are transformed into nodes of the graph during the generation of the graph. The graph can be built up step-wise with the inventive analysis of single sentences of a text document.

If a further one of the information portions, i.e. sentences of an electronic text document are analyzed, further new nodes, representing new ones of the different information elements such as new added subject nouns and new added object nouns, can be added to the graph and linked to each other and to other ones of the nodes via edges according to their analyzed relations. The edges can represent, for example, verbs which connect the subject noun with the object noun. As a result, it is also possible that the relation between two of the nodes (representing, for example, one subject and one object) can comprise one or more edges (representing, for example, one or more verbs). The nodes can comprise an active status or a passive status depending on the analyzed information portion, i.e. sentences. An active status or activated status of a node means that when the graph or at least a portion of the graph is evaluated to determine and analyze an ambiguous information portion to resolve the ambiguity such a node is used for the determination of the ambiguity. If a node has or is in a passive status then this node does not contribute to resolve an ambiguous information portion during the evaluation of the graph. Further, also edges can comprise an active status or a passive status. In an alternative aspect of the invention a node and/or an edge that is already existent in the graph can also be activated or deactivated during the generation of the graph depending on the analyzed information portion, i.e. sentence. The activation or deactivation of the nodes and/or the edges could follow the course of a saturation curve. The active or passive status of nodes and/or edges can be both relevant for generating and/or evaluating the generated graph or a portion of the generated graph.

The nodes of the dynamically generated graph can be assigned a specific weight or property. The same aspect can relate to the edges. The weight of one of the nodes, i.e. the node weight within the generated graph, can depend on or comprise, for example, the frequency number of the corresponding information element that appears in the analyzed part or portion of the information source. Further, the weight of the node, wherein the node represents an information element of an analyzed information portion, can depend on it's or involve a chronological distance to a previous analyzed information portion with the same information element. The chronological distance can involve a recording of the history of activation or deactivation and/or the distance to a previously analyzed information portion where the same node, i.e. information element is involved.

Every time that an information element is encountered in an information portion which is associated or corresponds to its corresponding node in the graph, then the corresponding node in the graph can be activated and/or, for example, the frequency number of the corresponding node can increase accordingly. The time of the activation or deactivation and/or the duration of activation and/or deactivation can be registered or recorded and can be used as a further weight or further part of a present weight of the node. The time of activation of a node can be dependent on the location where the corresponding information element appears in the analyzed information portions.

Such information can contribute to an actual, i.e. dynamic status of the generated graph. So the status of the generated graph can change with every further analyzed information portion, for example, sentence. The increase in the weight of the node with regard to its activation can, for example, follow the course of a saturation curve. In other words, after a specific number of activation of a node, no further activation of this node can be performed. Every analysis of an information portion, i.e. a sentence, can lead to a damping, i.e. deactivation of activated nodes. For example, if a node has been activated only once four sentences previously, then the node has comparatively a very slow activation, i.e. such a node has little influence on the analysis of, for example, an ambiguous sentence that has to be currently analyzed. The decrease of the activation of a node can be, for example, exponential.

With the generated graph, i.e. the information that is included in the nodes and edges and their status information, i.e. whether if the nodes and/or edges are activated or not, the method according to the present invention is able to use such information from the generated graph to resolve information portions, i.e. sentences, which are of ambiguous character. For example, every time that the method analyses a sentence where the content of the sentence, i.e. its meaning, is not clear if the sentence is only regarded by itself, then the method is able to determine a context-sensitive interpretation of the sentence that makes sense of the sentence. This context-sensitive interpretation of the sentence uses the knowledge of previous analyzed sentences. The interpretation assumes that the sentences have a meaning and something in common with the analyzed sentence of ambiguous character. If the previously analyzed sentences, represented by the graph, are not sufficient to resolve the ambiguity in the current sentence, then it is, for example, possible that at least one further sentence is analyzed and transferred to the graph. Further aspects of the invention are described in the following.

According to a second aspect of the invention, the method can further comprise continuing the analysis of the further ones of the plurality of information portions and the addition of further nodes and further edges to the graph until at least a further ambiguous one of the further ones of the plurality of information portions of the at least one information source is determined and analyzed by evaluating at least a portion of the generated graph. The invention therefore allows multiple ambiguities to be resolved by building up the generated graph.

According to a third aspect of the invention, the method can further comprise continuing the analysis of the further ones of the plurality of information portions and the addition of further nodes and further edges to the graph until a last remaining one of the plurality of information portions is analyzed. This allows, for example, that the content of a whole information source, i.e. a whole text document, to be analyzed and represented by the graph. The graph is a semantic representation of the whole document and can be used for the analysis of further different information sources, for example, electronic text documents with information portions of ambiguous character. It is clear for the person skilled in the art that a generated graph of partially analyzed information source can also be used for such a further processing.

According to a fourth aspect of the invention, the analysis of one of the plurality of information portions may further comprise parsing the one of the plurality of information portions. As already mentioned, parsing serves for the determination of the syntax, i.e. the grammatical types of the information elements. In one aspect of the invention, the information source can be parsed completely before generating the graph or at least partially and step-wise in dependence of the information portions. Parsing or the parsing strategy can also be realized according to a predefined set of rules.

According to a further aspect of the invention, the analysis of the plurality of information portions can further comprise selecting the one of the plurality of information portions in accordance to a rule. This allows, for example, that information portions need not be analyzed in a fixed order or sequence. For example, if the second sentence of one information source, i.e. text document is an ambiguous sentence and this ambiguous sentence can not be determined or resolved by evaluating the generated graph, previously generated from the first analyzed unambiguous sentence, then the method according to the invention is able to select at first a further sentence for analysis and further generation of the graph, the further sentence being of unambiguous type, and then resolve the second unambiguous sentence with the generated graph from the first sentence and the further sentence. As already mentioned, the selection of, for example, a further information portion can be in accordance to a rule or a pre-defined strategy. The selection of information portions can be, for example, a dynamic selection according to which at first all information portions, i.e. all sentences of unambiguous type are recognized and detected as unambiguous ones and used for the analysis and the generation of the graph.

In accordance with a further aspect of the invention, the generation of the graph can further comprise evaluating the at least one first information element in accordance to a rule. This aspect of the invention allows that the nodes and/or edges of the graph to be generated according to different criteria which can be defined individually. For example, the evaluation of a node and/or an edge can be specified statically or dynamically. In other words, preferences of the interpretation of node properties or node weights such as the activation status and/or the frequency number can be adjusted according to a rule or a set of rules.

Generating the graph may further comprise integrating the at least one first information element to the generated graph in accordance to a rule. Transforming can comprise a direct mapping of information elements to the graph or according to a set of rules. This allows a fine control of the method according to the invention and increases the flexibility as well as the operation speed.

In compliance with a next aspect of the invention, generating the graph may further comprise determining at least one first initial node weight of the at least one first initial node in accordance to a rule. This could involve, for example, a so-called tf-idf (term frequency inverse document frequency) value of the at least one first initial node to the at least one first initial node weight. As already mentioned, the node weight can be dependent on the frequency of the corresponding information element and/or its time history i.e. place where the information element appears in the information source. According to a further aspect of the invention, a corresponding tf-idf value can be multiplied with the corresponding nodes, i.e. node weights to generate a graph that is a thematically semantic representation of an information source. This corresponds to the meaning of the analyzed information source in comparison with further information sources. The structure or the structural layout of the generated graph is the same as without the applied tf-idf values. However, the status of the generated graph is different. Further, an index can be extracted from such a graph with applied tf-idf values. The index can represent the relation of the analyzed information source with regard to further information sources.

Generating the graph may, in accordance with another aspect of the invention, further comprise determining at least one first node relation, i.e. first edge weight between the at least one first initial node and the at least one second initial node in accordance to a rule. The at least one first node relation, i.e. first edge weight can be represented by the at least one first edge in the generated graph.

In an alternative aspect of the invention, the at least one first node relation, i.e. first edge weight can represent a semantic relation. For example, the first edge weight can represent a verb between a subject and an object of a sentence and its frequency between the subject and the object.

According to a further aspect of the invention, the graph is a dynamic graph, i.e. the graph is being dynamically varied and does not remain static.

Further, the graph can comprise at least one n-order k-graph.

In an alternative aspect of the invention, the at least one n-order k-graph may comprise a first-order k-graph.

According to a further aspect of the invention, analyzing a further one of the plurality of information portions can further comprise parsing the further one of the plurality of information portions. This allows, for example, that just one sentence is analyzed and evaluated before the next sentence is analyzed. Thus, the method is more flexible und efficient in terms of data processing.

According to a another aspect of the invention, analyzing a further one of the plurality of information portions may further comprise selecting the further one of the plurality of information portions in accordance to a rule. This leads, for example, to different processing of information sources of different type of which their content is of the same matter.

Analyzing a further one of the plurality of information portions can further comprise evaluating the further one of the plurality of information portions in accordance to a rule. This allows, for example, as already mentioned above, to different processing of information sources of different type of which their content is of the same matter

In compliance with a further aspect of the invention, analyzing a further one of the plurality of information portions can further comprise determining at least one further node weight of the added further nodes in accordance to a rule. This rule could be, for example, adding a tf-idf value of the added further nodes to the at least one further node weight or multiplying a tf-idf-value of the added further nodes to corresponding further node weights.

In accordance to a further aspect of the invention, analyzing a further one of the plurality of information portions may further comprise determining at least one further node relation, i.e. further edge weight between associated ones of the added further nodes as well as associated ones of the initial nodes and the associated ones of the added further nodes in accordance to a rule. The at least one further node relation, i.e. further edge weight can be represented by the at least one further edge.

The at least one further node relation, i.e. further edge weight can represent a semantic relation.

In accordance with another aspect of the invention, analyzing a further one of the plurality of information portions can further comprise adapting at least one of the at least one node weights in dependence of at least a further one of the at least one node weights in accordance to a rule.

In accordance with a further aspect of the invention, analyzing a further one of the plurality of information portions may further comprise adapting at least one of the at least one node relations, i.e. edge weights in dependence of at least a further one of the at least one node relations, i.e. edge weights in accordance to a rule.

In compliance with a further aspect of the invention, continuing the analysis can further comprise identifying the first ambiguous one of the plurality of information portions in accordance to a rule.

Evaluating at least a portion of the graph may further comprise determining the identified first ambiguous one of the plurality of information portions in accordance to a rule.

In accordance with a further aspect of the invention, the at least one information source can comprise at least one electronic text document.

The at least one of the plurality of information portions may comprise at least one textual element, for example, a pronoun, etc.

The method according to the invention may be a computer implemented process.

In accordance with another aspect of the invention, an apparatus is provided for semantic parsing at least one information source. The apparatus comprises at least one graph processing engine for generating a graph from a plurality of information portions of the at least one information source and evaluating at least a portion of the generated graph. The apparatus further includes at least one information portion analyzing engine for incremental analyzing a selected one of the plurality of information portions and transmitting the results of the analyzed information portions to the at least one graph processing engine and, on detection of an ambiguity, resolving the meaning of the ambiguity by using, i.e. evaluating the generated graph. Furthermore, the apparatus includes at least one output device for presenting the generating graph. The apparatus can be, for example, part of a electronic data processing apparatus such as a server, personal computer, PDA, etc. or a mobile telephone or any kind of electronic apparatuses for communication or with access to a storage device or a communications network storing or providing one or more information sources as described above.

In accordance with another aspect of the invention, there is provided a computer readable tangible medium which stores instructions for implementing the method run on a computer. The instructions control the computer to perform the process of semantic parsing at least one information source as discussed previously. The computer readable tangible medium can be a floppy disk, CD-ROM, DVD, USB flash memory or any other kind of storage device. Alternatively, the instructions for implementing and executing the method according to the present invention can be downloaded via a communications networks such as intranets, the Internet, etc. In an alternative aspect of the invention, the instructions for implementing and executing the method according to the present invention can be stored on a mobile communication device with access to a communications network such as a mobile phone, etc.

In accordance with another aspect of the invention, a computer program product is provided. The computer program product is loadable into at least one memory of a computer readable tangible medium or into an electronic data processing apparatus. Such an apparatus can be, for example, an apparatus as described above. The computer program product comprises program code means to perform the semantic parsing at least one information source as discussed previously.

According to another aspect of the invention, the method according to the present invention can be implemented in web browsers or linked to web browsers to assist the web browsers which have access to communication networks such as intranets, the Internet, etc.

According to a further aspect of the invention, the method according to the invention can be implemented in search algorithms of, for example, well-known search services of search-engines to improve their efficiency, quality and reliability.

According to a further aspect of the invention, a search engine apparatus for executing the method as discussed previously is provided.

These together with other advantages and objects that will be subsequently apparent, reside in the details of construction and operation as more fully herein described and claimed, with reference being had to the accompanying figures.

It is clear for the man skilled in the art that the disclosed characteristics and features of the invention can be arbitrarily combined with each other.

### BRIEF DESCRIPTION OF THE DRAWINGS

FIG. 1 is an example of an information source comprising ambiguous information portions;

FIG. 2 is an example of a schematic graphical representation of a generated graph of the information source shown in FIG. 1;

FIG. 3 is a flowchart of an example of the method according to the invention;

FIG. 4 is an example of a schematic representation of an apparatus for performing the method according to the invention.

### DETAILED DESCRIPTION OF THE INVENTION

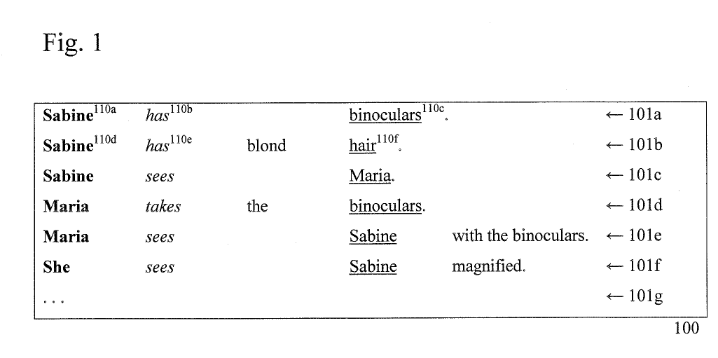

FIG. 1 shows a simple example of a portion of an information source 100 that is analyzed by an example of the method according to the present invention using, for example, the apparatus as described above. In the example illustrated in FIG. 1, the information source 100 is a text document 100 comprising English language text, i.e. information about the exemplary chosen characters “Sabine” and “Maria”. The text document 100 comprises six information portions, i.e. sentences 101a-101f that are shown in FIG. 1. Further information portions 101g are merely indicated by three dots and not explicitly shown in FIG. 1. The text document 100 can be, for example, an electronic text document, i.e. a text document that can be processed by an electronic data processing apparatus. Further, the text document 100 can be stored, for example, on a local computer and/or distributed and accessible over a communications network such as intranets, the Internet, etc.

The text document 100 includes a first sentence 101a: “Sabine has binoculars”, a second sentence 101b: “Sabine has blond hair”, a third sentence 101c: “Sabine sees Maria”, a fourth sentence 101d: “Maria takes the binoculars”, a fifth sentence 101e: “Maria sees Sabine with the binoculars” and a sixth sentence 101f: “She sees Sabine magnified.”

Each ones of the sentences 101a to 101f of the text document 100 are made up of at least a basic set of information elements 110, i.e. subjects, verbs, objects, etc. For a human reader each ones of the sentences 101a to 101f makes sense and communicates a special message to the human reader. Each ones of the sentences 101a to 101f is also understandable when read alone. However, the information content of the sentences is quite of different kind for a human reader.

However, without the previous knowledge of the first five sentences 101a to 101e, it would be not possible, for example, to exactly determine who or what is meant with the term “She” in the sixth sentence 101f. The sixth sentence 101f represents a sentence having ambiguous, i.e. unclear information.

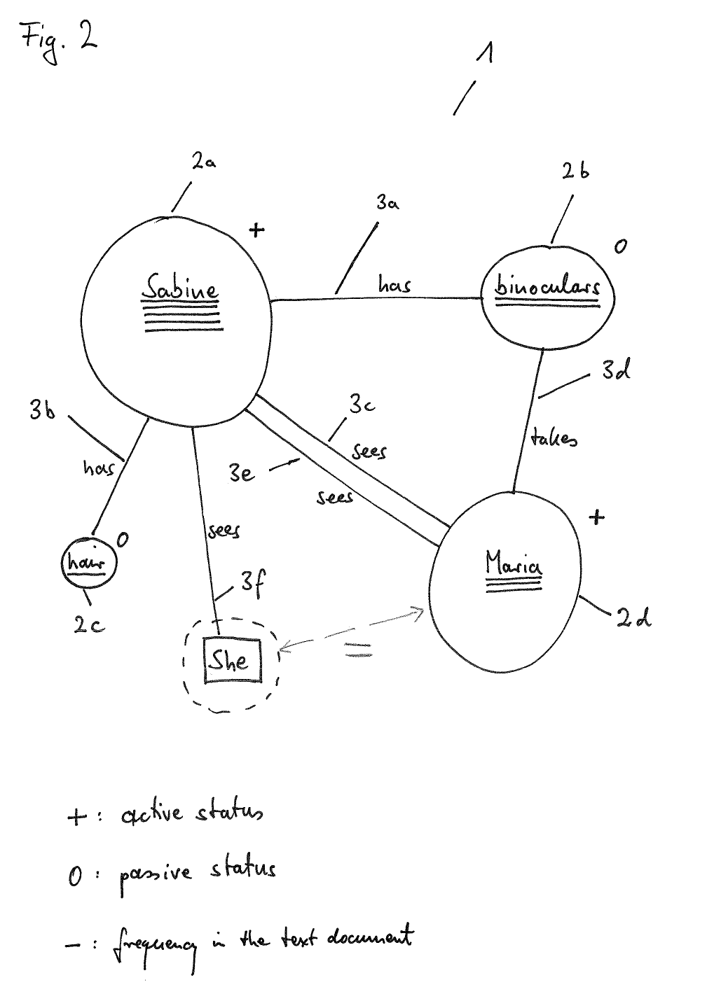

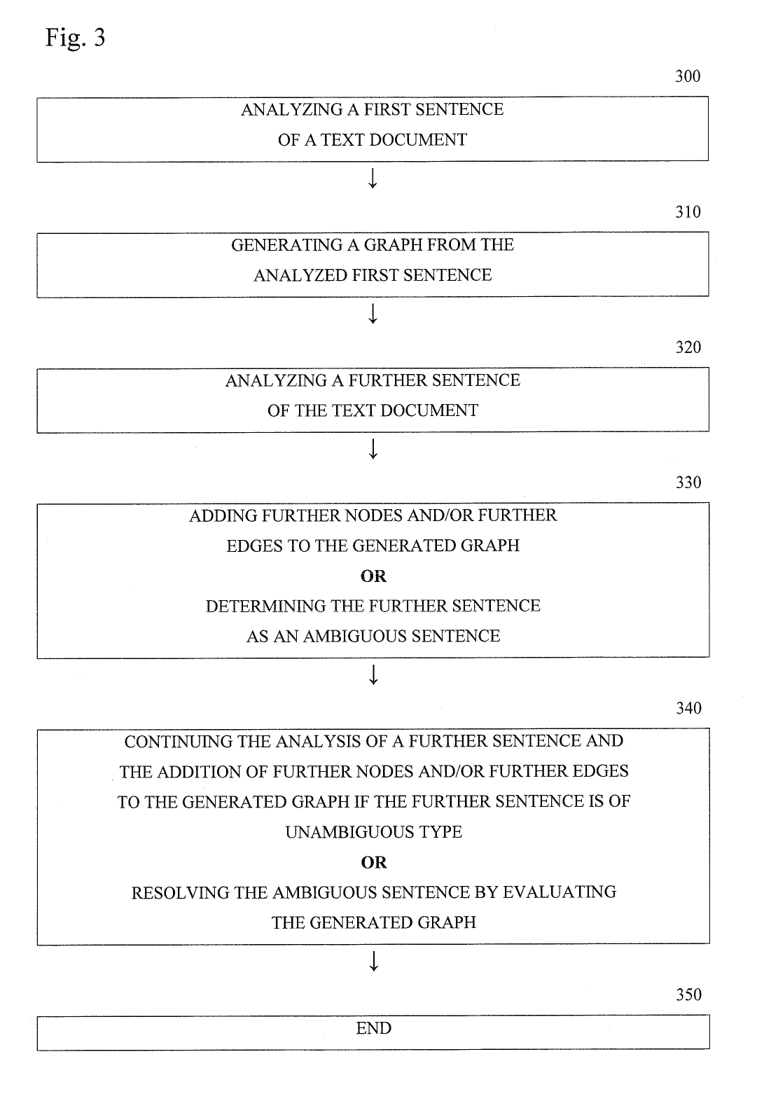

With the method according to the present invention, the ambiguous information of the sixth sentence 101f can be analyzed and determined, i.e. resolved. This resolution is done in the following manner with the help, i.e. the evaluation of a dynamically generated graph 1 (see FIG. 2). An example of the method is illustrated in FIG. 3.

In a first phase 300, the first, i.e. initial sentence 101a is analyzed. The analysis is done, for example, by a parsing analysis using a “shallow parser”. The parsing analysis detects and/or determines the kind of the information elements in the sentence 101a, i.e. the subject noun 110a: “Sabine”, the verb 110b: “has” and the object noun 110c: “binoculars”. It is clear for the person skilled in the art that the analysis is not only limited to determine only the subject noun, verb and object noun of a sentence, but could also include other kinds of information elements such as adjectives, etc. The determination can be executed in conjunction with a given set of grammar rules. It is clear, that the given set of grammar rules can be adapted to the language of the information source 100 that has to be analyzed. In contrast to an at least partially and step-wise parsing of a single sentence 101, the information source 100, i.e. the text document 100 can be, for example, completely parsed before the graph 1 is generated. The parsing can be performed using different varieties of parsing strategies as described above. In an alternative aspect of the invention, the method for semantic parsing, i.e. the analysis can be started by selecting an arbitrary sentence, for example, the second sentence 101b. The selection of such a “start” information portion 101, i.e. start sentence 101 can be performed in accordance to a predefined rule or a set of rules. For example, if the first, i.e. initial, sentence 101 is determined as an ambiguous sentence 101, then a further sentence 101 is analyzed for ambiguity and the generation of a graph 1 is generated from an analyzed and determined non-ambiguous sentence 101.

In the next step 310, after the information elements 110 of the first, i.e. initial sentence 101a have been detected and their types have been identified, the information elements 110 are transferred and/or transformed to generate at least a portion of the graph 1, i.e. to build up the first semantic relation, the first portion of the graph 1. The transferring and/or transformation of the analyzed and determined relevant information portions 110 into corresponding nodes 2 of the graph 1 can be performed in accordance to a rule or a set of rules. The graph 1, representing the initial analyzed sentence 101a, comprises at least two nodes 2, the first initial node 2a or first node 2a representing the analyzed first information element 110 and the second initial node 2b or second node 2b representing the analyzed second information element 110. The two initial nodes 2a, 2b are associated via at least one edge 3a. The at least one edge 3a represents an analyzed third information element 110.

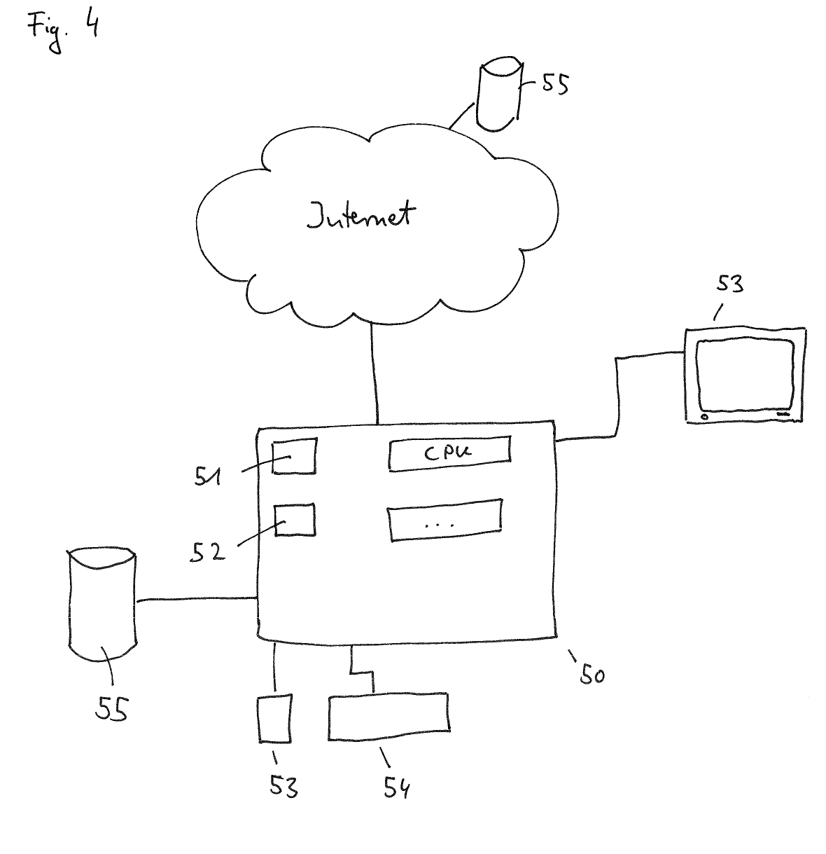

With regard to the first analyzed sentence 101a of text document 100 (see FIG. 1), the first node 2a in the graph 1 represents the first analyzed and detected information element 110a, i.e. the subject noun 110a (“Sabine”). The second node 2b in the graph 1 represents the second analyzed and detected information element 110c, i.e. the object noun 110c (“binoculars”). The first node 2a and the second node 2b are connected via the edge 3a. The edge 3a represents the third analyzed and detected information element 110b, i.e. the verb 110b (“has”). Since the method according to the invention can be a computer implemented method, the graph 1 can be represented as a matrix or vector and stored in a computer memory (see FIG. 4).

The analyzed information elements 110 of the first sentence 101a which are represented by two nodes 2a and 2b and one edge 3a in the graph 1 can be evaluated in accordance to a rule or a set of rules. For both the first node 2a and the second node 2b a first initial node weight and a second initial node weight can be determined by a method according to the invention. The determination of the node weights can be performed in accordance to a rule or a set of rules. The node weight can, for example, represent the frequency number of an information element 110 in the analyzed information portions 101. In the graph 1 of FIG. 2 the frequency number of each node 2a to 2d is graphically represented by the underlining underneath each of the term within the nodes 2a to 2d of the analyzed information elements 110. Since the subject noun “Sabine”, represented by node 2a and the object noun “binoculars”, represented by node 2b, are contained one time in the first sentence 101a a frequency number of one for both information elements 110 can be determined.

As previously discussed, the edge 3a represents a node relation between the first node 2a and the second node 2b, the first node 2a and the second node 2b represent initial nodes. The node relation represents a semantic relation, i.e. the first node 2a and the second node 2b have a relation to each other. Similar to the first node 2a and the second node 2b, the edge 3a can have an edge weight. The edge weight can, for example, represent the frequency number of always the same type and content of a specific information element 110 between two different ones of the further information elements 110, i.e. an information element 110 that associates to different ones of the information elements 110 (e.g. the frequency number of a verb always between the same subject noun and the same object noun in a plurality of analyzed sentences).

In step 320 a further information portion 101b, i.e. the second sentence 101b of the text document 100, is analyzed and the relevant ones of the information elements 110 are detected and determined. The analysis of the further, i.e. second, sentence 101b can be, as already mentioned, performed by a parsing algorithm. The detected relevant information elements 110 of the sentence 101b are the previously identified subject noun 110d: “Sabine”, the verb 110e: “has” and the new object noun 110f: “hair”. The detection, i.e. analysis, for example via parsing methods, of such information elements 110 can be performed as previously described. In an alternative aspect of the invention, a different sentence 101 from the second sentence 101b can be selected for the analysis. The selection of the further sentence 101 to be analyzed can be performed in accordance with a rule or a set of rules. For example, the analysis of an information source 100, i.e. a text document 100, can be continued, for example, using the information portions 101, i.e. sentences 101 at the end of the text document 100. The initial sentence and/or one or more further sentences 101 can be alternatively analyzed and evaluated according to a rule or a set of rules that differs from parsing strategies.

In step 330 the method can determine if the analyzed information elements 110, i.e. the corresponding second sentence 101b, is an ambiguous sentence or not, i.e. whether the analyzed second sentence 101b involves an ambiguity or not. If the analyzed second sentence is not an ambiguous sentence, and this is the case in the example of FIG. 1, then the relevant information elements 110 are transferred and/or transformed into the graph 1 accordingly as described below.

Since the information element 110d “Sabine” is already existent in the graph 1 and represented by the first node 2a there is no generation of a further new node representing the already known information element 110d: “Sabine”. Since the object noun 110f “hair” was not existent in the previously analyzed first sentence 101a, a further new node 2c termed “hair” is added the generated graph 1. New or further added node 2c (“hair”) is associated to the first node 2a representing the object noun “Sabine” via the new added edge 3b, i.e. the detected verb 110e (“has”). The information element 110c “binoculars” are not contained in the second analyzed sentence 101b.

As already mentioned, since the information element 110d “Sabine” is contained in the first sentence 101a as well as in the second sentence 101b, a corresponding new node weight can be determined for the first node 2a, representing “Sabine”. The previous node weight of node 2a can be updated or redefined.

Further, the first node 2a can have a further weight and thus be brought into an activated status, i.e. is activated (marked with a “+” in FIG. 2). The activation of a node 2 can implicate that the corresponding information element 110 is existent both in the previous one or more sentences, i.e. here in the first sentence 101a as well as in the current analyzed sentence (here the second sentence 101b) of the text document 100. Since the term “binoculars” is not contained in the second analyzed sentence 101b the corresponding node 2b can be brought in a deactivated, i.e. passive status (marked with “0” in FIG. 2).

Each newly generated one of the nodes 2 can be initially in an activated status. In other words, the activation status of a node 2 can represent the places or locations of the analyzed information portions 101 with such an information element 110, i.e. where always the same information element 110 appears. In an alternative aspect of the invention, each newly generated one of the nodes 2 can be initially in an deactivated, i.e. passive status.

In an alternative aspect of the invention, at least one edge 3 that is already existent in the graph 1 can also be activated or deactivated during the generation of the graph 1 depending on the analyzed information portion 101, i.e. sentence 101. The activation or deactivation of the nodes 2 and/or the edges 3 in the graph 1 could follow the course of a saturation curve. The active or passive status of nodes 2 and/or edges 3 can be both relevant for generating and/or evaluating the generated graph 1 or a portion of the generated graph 1.

The node weight concerning the status of a node can be, for example, the number of activations and/or deactivations for each node 2 and/or edge 3. Such a number can be recorded and stored, for example, in a memory. Such information may be relevant for the evaluation of the generated graph 1, i.e. which nodes 2 and/or edges 3 have influence to other different nodes 2 and/or edges 3 and/or which nodes 2 and/or edges 3 do not contribute to the evaluation of the graph 1 or have at least a specific influence to the evaluation of the graph 1.

As already mentioned, the underlining underneath each of the term of the analyzed information elements 10 in the graph 1 can represent, for example, the frequency number of each relevant and extracted information element 10 from the analyzed information portions 101 of the text document 100. The frequency number may be a further weight of the nodes 2.

Since the second information portion 101b, i.e. the second sentence 101b has been analyzed then the third sentence 101c is analyzed, determined and transferred and/or transformed to the graph 1 as described above. The above described phases are repeated for the further non-ambiguous sentences 101c to 101e. If the further subject nouns and/or object nouns are different from initial or known subject nouns and/or objects nouns further nodes 2d and/or further edges 3c, 3e are added to the generated graph 1 only one time and then manipulated accordingly as previously described.

In other words, if a subject noun and/or an object noun is already represented by a node 2a, 2b, 2c, 2d then the same node 2a, 2b, 2c is used. There is no generation of further nodes for the same information element 10. The initial nodes 2a, 2b are linked to the further added nodes 2c, 2d via edges 3b to 3e. The graph 1 is generated dynamically with each further analyzed information portion 101, i.e. sentence 101. In other words, the determination of the information elements 10 is carried out to see whether all of the information elements 110 have been analyzed. If further information elements 110 are still not all analyzed, then, the same steps are performed with each of the further sentences 101c to 101e.

As already mentioned, for each one of the nodes 2a to 2d of the graph 1 a node weight is determined and applied to the node 2a to 2d as well as updated after analyzing a further information portion 101, i.e. a further sentence 101. Each node weight that relates to the frequency number of each information element 110 in the analyzed part or portion of text document 100 in FIG. 2 is represented by the number of underlines of the corresponding terms of the information element 10.

Each one of the edges 3a to 3d represents a node relation. The graph 1 is a semantic representation of the analyzed information portions 101a to 101e. In other words, the structural layout of the graph 1, i.e. the relation between the nodes 2 to further nodes 2 and the weights of the nodes 2 (e.g. frequency number, activation information/history, etc.) and/or the weight of the edges 3 can be used to determine and extract a meaning of the analyzed information portions 101a to 101e. Further, such a meaning can be used for further proceedings with regard to information portions 101f which are of ambiguous type. Such a scenario will be exemplary described in the following with regard to the exemplary information source 100, i.e. text document 100 in FIG. 1.

When the analysis reaches the sixth sentence 101f in step 330 which is an ambiguous sentence, because of its undefined subject noun “She”, then the ambiguous sentence 101f is determined as an ambiguous sentence 101f and analyzed to determine who or what is meant with the term “She”. The determination of the term “She” can be performed as exemplary described below.

The resolution of the ambiguous sentence 101f is carried out in step 340 by evaluating the generated graph 1 to resolve the ambiguity of the sixth sentence 101f. If the sixth sentence 101f has not been recognized or determined as an ambiguous sentence, then the analysis would continue and possibly further nodes 2 and/or further edges 3, the further nodes 2 representing further different, i.e. new information elements 110 are added to the graph 1. If detected or determined information elements 110 are already known in the graph 1 (resulting from previous analyzed information portions 101, i.e. sentences 101), then the nodes 2 that correspond to these information elements 110 are updated with regard to their weights (e.g. determine a new frequency number of relevant nodes 2, new status information of relevant nodes 2, etc.).

With regard to the exemplary text document 100 (see FIG. 1) about the two characters “Sabine” and “Maria” the node weights of the nodes 2, in particular the nodes 2a and 2d of the graph 1 are used to resolve the ambiguity. The resolution is performed under consideration of the structural layout of the generated graph 1 i.e. the relation between respective nodes 2 and the weights of the nodes 2 and/or edges 3. As already mentioned, the node weights can comprise the number of frequency of the corresponding information elements 100 in the previously analyzed sentences. With regard to the five sentences 101a to 101e of the text document 100 in FIG. 1 and the generated graph 1 in FIG. 2, the graph 1 being generated from these five sentences 101a to 101f, the information element 110a (“Sabine”) has the highest frequency number. The information element “Sabine” is contained five times in the analyzed sentences 101a to 101f. Further, the information element “Maria” is contained three times in the analyzed sentences 101a to 101f.

The node 2a (“Sabine”) is connected to the node 2d (“Maria”) via two the edges 3c and 3e. The two edges 3c and 3e represent the same information portion 110, i.e. verb (“sees”). Further, only the nodes 2a and 2b are activated (at the time when the sixth sentence 101f, i.e. the ambiguous sentence 101f is analyzed), i.e. in an activated status (marked with a “+” in FIG. 2), because these information elements appeared in the last four analyzed sentences 101c to 101f. Following, these nodes involve the highest relevancy for the determination of the ambiguity. In an alternative aspect of the invention, the number of activations of a node 2 can also be regarded as a node weight and used for the evaluation of the generated graph 1 to determine and resolve an ambiguous information portion 101f.

As already mentioned, the determination, i.e. the resolution of the ambiguity is performed under consideration of the above discussed properties of nodes, i.e. the node weights, i.e. their frequency numbers and their statuses, i.e. status information (activated or deactivated i.e. passive). The method determines with a specific probability what known one of the information elements 110, each represented by one of the nodes 2, makes sense under consideration of the previous analyzed information portions, i.e. sentences 101a to 101f. Since the two nodes 2a and 2d are the nodes 2 of the highest relevancy and energy, i.e. the nodes 2 with the highest frequency number and most relevant status information (activated statuses), the method according to the invention detects and/or calculates that the term “She” could most likely correspond to the information element “Maria”. Since the method can be a computer implemented process, the graph 1 can be represented by a matrix and the evaluation of the graph 1 can be performed using well-known matrix operation schemes.

The evaluation of the generated graph 1 can also be performed under consideration of node relations, i.e. edge weights. As already mentioned, each edge 3 can have, for example, an edge weight representing the strength of association between two nodes 2. Such an edge weight represents a semantic relation.

The determination, i.e. resolution of an ambiguity can be adjusted by a, for example, predefined probability criterion. If the ambiguous sentence can not be analyzed and determined within the predefined probability criterion, then the method is able, to analyze further information portions which are of unambiguous type and further generate the graph 1 and try then to resolve the ambiguity. The selection of further information portions 101g can be performed in accordance to a rule or a set of rules. The probability criterion can be defined in accordance to a rule or a set of rules. For example, the probability criterion may change its value during the analysis of information portions 101f. Alternatively, the probability criterion may be externally adjusted by a user.

For the evaluation of the generated graph 1 at least one weight of a node, i.e. node weight can be adapted in dependence of at least a further one node weight of a further node in accordance to a rule or a set of rules. The same aspect may be performed for at least one edge weight.

If the ambiguity, i.e. the ambiguous sentence 101f, is resolved, then the method can be finished in step 350. In an alternative aspect of the invention, the method can further comprise continuing the analysis of the further ones 101g of the plurality of information portions 101, i.e. sentences and the addition of further nodes 2 and further edges 3 to the graph 1 until at least a further ambiguous one of the further ones of the plurality of information portions, i.e. sentences 101 of the information source, i.e. text document 100 is determined and analyzed by evaluating at least a portion of the generated graph 1. It is clear for the person skilled in the art, that for analyzed and determined information elements 110 which are already known in the graph 1, i.e. the analyzed and determined information elements 110 correspond to already present nodes 2 the weights of these nodes 2 (e.g. frequency numbers, activation information, etc.) are merely updated or changed accordingly. This allows multiple ambiguities to be resolved by building up and continuously evaluating the generated graph 1.

The analysis of further sentences 101 and the generation of a corresponding graph 1 can be continued until the last remaining information portion 101 of the information source has been analyzed, i.e. the whole information source is transferred into a graph 1.

The graph 1 may be an n-order graph 1. In an alternative aspect of the invention, the graph 1 may be a first-order k-graph 1. A k-graph is a graph by dividing a set of edges of a graph (1, 2, 3, . . . , k, . . . , n) into k−1 pair wise disjoint subsets. The graph edges of degree n₁, . . . , nₖ₋₁ satisfy n=n₁+n₂+ . . . +nₖ₋₁ and two graph vertices joined iff they lie in distinct graph edge sets.

After the graph 1 has been generated, tf-idf values can be added or multiplied with corresponding node weights before the generated graph 1 is analyzed and evaluated to determine, analyze and resolve an ambiguous information portion 101. In an alternative aspect of the invention, the relation between two nodes 2, i.e. an edge 3 is determined in accordance to a rule or a set of rules and used for the evaluation of the graph 1.

In a further aspect of the invention, the node weights can be adapted with if-idf-values of the corresponding information elements 110. Tf-idf-values can be added to corresponding node weights or multiplied with corresponding node weights.

FIG. 4 shows an example of a schematic representation of an apparatus 50 for performing the method according to the invention. The apparatus 50 can be, for example, an electronic data processing apparatus such as a personal computer, a server, a web-server, a terminal, a PDA, etc. with access to at least one electronic file, i.e. information source database and/or to a mobile communications network with access to electronic information sources such as downloadable text documents, web pages, etc. Further, the apparatus 50 can be a mobile communications device such as a mobile phone, a smart phone, etc. The apparatus 50 can also be, for example, part of a electronic data processing apparatus such as a server, personal computer, PDA, laptop, etc. or a mobile telephone or any kind of electronic apparatuses for communication or with access to a storage device or a communications network storing or providing one or more information sources as described above.

The apparatus 50 of FIG. 4 comprises a graph processing engine 51 for generating a graph from a plurality of information portions 101 of the at least one information source 100 and evaluating at least a portion of the generated graph 1. The apparatus 50 further includes a information portion analyzing engine 52 for incremental analyzing a selected one of the plurality of information portions 101 and transmitting the results of the analyzed information portions 101 to the graph processing engine 51 and, on detection of an ambiguity, resolving the meaning of the ambiguity by using, i.e. evaluating the generated graph 1. Furthermore the apparatus 50 is connected to an output device 53 for presenting the generated graph 1 and the results of the analyzed at least one information source 100.

The apparatus 50 of FIG. 4 is further connected to data input devices such as a keyboard 54, a computer mouse 53, etc. The apparatus 50 may further be connected to an external database 55 storing a plurality of information sources 100. The external database 55 may be connected directly to the apparatus 50 or accessible via a communications network such as the Internet to the apparatus 50. Since the apparatus 50 is a computer it may further comprise a cd-rom drive, a floppy drive, a hard drive, a disk controller, a ROM memory, a RAM memory, communication ports, a central processing unit, etc.

Since the invention has been described in terms of single examples, the man skilled in the art will recognize that the invention can be practiced with modification within the spirit and scope of the attached claims.

At least, it should be noted that the invention is not limited to the detailed description of the invention and/or of the examples of the invention. It is clear for the person skilled in the art that the invention can be realized at least partially in hardware and/or software and can be transferred to several physical devices or products. The invention can be transferred to at least one computer program product. Further, the invention may be realized with several devices.

What is claimed is:

1. A method for semantic parsing at least one information source, the at least one information source having a plurality of information portions, each one of the plurality of information portions comprising at least one first information element being associated with at least one second information element, the method comprising:
analyzing one of the plurality of information portions of the at least one lo information source;
generating a graph from the plurality of information portions to obtain at least one first initial node representing the at least one first information element and having a first initial weight, at least one second initial node representing the at least one second information element and having a second initial weight, and at least one first edge connecting the at least one first initial node with the at least one second initial node;
analysing a further one of the plurality of information portions of the at least one information source to determine further ones of the at least one information elements;
adding further nodes with further weights to the generated graph representing the further ones of the at least one information elements, and adding further edges to the generated graph between associated ones of the added further nodes as well as associated ones of the initial nodes and the associated ones of the added further nodes; and
continuing the analysis of the further ones of the plurality of information portions and the addition of further nodes, further weights and further edges to the generated graph until a first ambiguous one of the further ones of the plurality of information portions of the at least one information source is determined and analyzed by evaluating at least a portion of the generated graph.

2. The method according to claim 1, wherein the first initial weight is selected from the group consisting of a frequency number and activation information of the at least one first information element.

3. The method according to claim 1, further comprising continuing the analysis of the further ones of the plurality of information portions and the addition of further nodes and further edges to the graph until a further ambiguous one of the further ones of the plurality of information portions of the at least one information source is determined and analyzed by evaluating at least a portion of the generated graph.

4. The method according to claim 1, further comprising continuing the analysis of the further ones of the plurality of information portions and the addition of further nodes and further edges to the graph until a last remaining one of the plurality of information lo portions is analyzed.

5. The method according to claim 1, wherein analysing one of the plurality of information portions further comprises parsing the one of the plurality of information portions.

6. The method according to claim 1, wherein analysing one of the plurality of information portions further comprises selecting the one of the plurality of information portions in accordance to a rule.

7. The method according to claim 1, wherein generating the graph further comprises evaluating the at least one first information element in accordance to a rule.

8. The method according to claim 1, wherein generating the graph further comprises integrating the at least one first information element to the generated graph in accordance to a rule.

9. The method according to claim 1, wherein generating the graph further comprises determining at least one first initial node weight of the at least one first initial node in accordance to a rule.

10. The method according to claim 9, wherein determining the at least one first initial node weight further comprises adding a tf-idf value of the at least one first initial node to the at least one first initial node weight.

11. The method according to claim 1, wherein generating the graph further comprises determining at least one first edge weight between the at least one first initial node and the at least one second initial node in accordance to a rule, the at least one first edge weight being represented by the at least one first edge.

12. The method according to claim 11, wherein the at least one first node relation represents a semantic relation.

13. The method according to claim 1, wherein the graph is a dynamic graph.

14. The method according to claim 1, wherein the graph comprises at least one n-order k-graph.

15. The method according to claim 7, wherein the at least one n-order k-graph comprises a first-order k-graph.

16. The method according to claim 1, wherein analysing a further one of the plurality of information portions further comprises parsing the further one of the plurality of information portions.

17. The method according to claim 1, wherein analysing a further one of the plurality of information portions further comprises selecting the further one of the plurality of information portions in accordance to a rule.

18. The method according to claim 1, wherein analysing a further one of the plurality of information portions further comprises evaluating the further one of the plurality of information portions in accordance to a rule.

19. The method according to claim 1, wherein analyzing a further one of the plurality of information portions further comprises determining at least one further node weight of the added further nodes in accordance to a rule.

20. The method according to claim 19, wherein determining the at least one further node weight further comprises adding a tf-idf value of the added further nodes to the at least one further node weight.

21. The method according to claim 1, wherein analyzing a further one of the plurality of information portions further comprises determining at least one further edge weight between associated ones of the added further nodes as well as associated ones of the initial nodes and the associated ones of the added further nodes in accordance to a rule, the at least one further edge weight being represented by the at least one further edge.

22. The method according to claim 21, wherein the at least one further node relation represents a semantic relation.

23. The method according to claim 19, wherein analyzing a further one of the plurality of information portions further comprises adapting at least one of the at least one node weights in dependence of at least a further one of the at least one node weights in accordance to a rule.

24. The method according to claim 21, wherein analyzing a further one of the plurality of information portions further comprises adapting at least one of the at least one edge weights in dependence of at least a further one of the at least one edge weights in accordance to a rule.

25. The method according to claim 1, wherein continuing the analysis further comprises identifying the first ambiguous one of the plurality of information portions in accordance to a rule.

26. The method according to claim 25, wherein evaluating at least a portion of the graph further comprises determining the identified first ambiguous one of the plurality of information portions in accordance to a rule.

27. The method according to claim 1, wherein the at least one information source comprises at least one electronic text document.

28. The method according to claim 1, wherein the at least one of the plurality of information portions comprises at least one textual element.

29. The method according to claim 1, wherein the method is a computer implemented process.

30. An apparatus for semantic parsing at least one information source, the apparatus comprising:
at least one graph processing engine for generating a graph from a plurality of information portions of the at least one information source and evaluating at least a portion of the generated graph; and
at least one information portion analyzing engine for incrementally analyzing a selected one of the plurality of information portions, transmitting the results of the analyzed information portions to the at least one graph processing engine and, on detection of an ambiguity, resolving the meaning of the ambiguity by using the generated graph.

31. A computer readable tangible medium storing instructions for implementing a process driven by a computer, the instructions controlling the computer to perform the process of semantic parsing at least one information source, the at least one information source having a plurality of information portions, each one of the plurality of information portions comprising at least one first information element being associated with at least one second information element, the semantic parsing at least one information source comprising:
analyzing one of the plurality of information portions of the at least one information source;
generating a graph from the plurality of information portions to obtain at least one first initial node representing the at least one first information element and having a first initial weight, at least one second initial node representing the at least one second information element and having a second initial weight, and at least one first edge connecting the at least one first initial node with the at least one second initial node;
analysing a further one of the plurality of information portions of the at least one information source to determine further ones of the at least one information elements;
adding further nodes with further weights to the generated graph representing the further ones of the at least one information elements, and adding further edges to the generated graph between associated ones of the added further nodes as well as associated ones of the initial nodes and the associated ones of the added further nodes; and
continuing the analysis of the further ones of the plurality of information lo portions and the addition of further nodes, further weights and further edges to the generated graph until a first ambiguous one of the further ones of the plurality of information portions of the at least one information source is determined and analyzed by evaluating at least a portion of the generated graph.

32. A computer program product, being loadable into at least one memory of a computer readable tangible medium or into an electronic data processing apparatus, the computer program product comprising program code means to perform semantic parsing at least one information source, the at least one information source having a plurality of information portions, each one of the plurality of information portions comprising at least one first information element being associated with at least one second information element, the semantic parsing at least one information source comprising:
analyzing one of the plurality of information portions of the at least one information source;
generating a graph from the plurality of information portions to obtain at least one first initial node representing the at least one first information element and having a first initial weight, at least one second initial node representing the at least one second information element and having a second initial weight, and at least one first edge connecting the at least one first initial node with the at least one second initial node;
the graph being a semantic representation of the analyzed one of the plurality of information portions;
analysing a further one of the plurality of information portions of the at least one information source to determine further ones of the at least one information elements;
adding further nodes with further weights to the generated graph representing the further ones of the at least one information elements, and adding further edges to the generated graph between associated ones of the added further nodes as well as associated ones of the initial nodes and the associated ones of the added further nodes; and
continuing the analysis of the further ones of the plurality of information lo portions and the addition of further nodes, further weights and further edges to the generated graph until a first ambiguous one of the further ones of the plurality of information portions of the at least one information source is determined and analyzed by evaluating at least a portion of the generated graph.

33. The computer program product of claim 32, wherein the program code means are executed on the computer readable tangible medium or on the electronic data processing apparatus.
